(19) United States
(12) Patent Application Publication
(10) Pub. No.: US 2014/0002846 A1
(43) Pub. Date: Jan. 2, 2014

(54) PRINT SYSTEM, PRINT SERVER AND CONTROL METHOD THEREOF, AND STORAGE MEDIUM

(71) Applicant: CANON KABUSHIKI KAISHA, Tokyo (JP)

(72) Inventor: Yuichi Kondo, Kawasaki-shi (JP)

(73) Assignee: CANON KABUSHIKI KAISHA, Tokyo (JP)

(21) Appl. No.: 13/889,977

(22) Filed: May 8, 2013

(30) Foreign Application Priority Data
Jun. 28, 2012 (JP) 2012-146082

(51) Int. Cl. G06F 3/12

(52) U.S. Cl. CPC G06F 3/1238
USPC 358/1.14

(57) ABSTRACT

A print server receives an electronic mail transmitted from a mobile terminal, generates print data corresponding to an attachment file of the received electronic mail and transmits to a print apparatus, as a print job, the generated print data and authentication information in a case where the authentication information is included in the received electronic mail. Printing of the print data is performed on the print apparatus in a case where authentication based on the transmitted authentication information and authentication information input by a user into the print apparatus succeeded.

### BACKGROUND OF THE INVENTION

1. Field of the Invention

The present invention relates to a print system in which printing is done according to an electronic mail from a mobile terminal, a print server and a control method thereof, and storage medium.

2. Description of the Related Art

Conventionally, there exists a technique in which in a case where print is performed from a mobile terminal, a file that a user wishes to print is attached to an electronic mail using electronic mail software of the mobile terminal, transmitted to a printer and caused to be printed. (for example, Japanese Patent Laid-Open No. 2004-220606) In this case, an electronic mail address is given to the printer beforehand, electronic mail with an attachment file is transmitted to that electronic mail address, and the contents of the attachment file are caused to be printed by the printer. More specifically, upon printer initialization, the printer makes a request to a server for an electronic mail address, acquires a unique electronic mail address, and retains it. On the other hand, the user, using the mobile terminal, attaches a file to be printed to an electronic mail and transmits that electronic mail to the electronic mail address of the printer. The server maintains a table that associates printers and electronic mail addresses, and when it receives an electronic mail to one of the electronic mail addresses, it refers to the table and identifies the printer, and causes print execution by that printer.

However, in the aforementioned conventional technique there is the necessity for the printer, upon printer initialization, to make the request for the electronic mail address to the server and to acquire an electronic mail address unique to the printer. Also, on the server side there is the necessity of managing the table that associates electronic mail addresses and printers.

Here, on the server, printer drivers for each printer are installed beforehand, and the server, when it receives an electronic mail, extracts the attachment file with a software application corresponding to the file extension of the attachment file. Then, it can be assumed that after converting the data using the printer driver corresponding to the target printer, it transmits it as a print job to the target printer.

When such a print system is realized, there is the possibility that when the user transmits an electronic mail with an attachment file, and as a result the printer performs a print, the print material that is printed according to the electronic mail could coexist with print material of other print jobs.

Particularly on a printer used by many users, because print materials printed by the different users coexist, there is the possibility that important print material could get mixed into the middle of another person's print materials. Also, it is not desirable for important printed material to be left on a discharge tray of a printer for a long time.

### SUMMARY OF THE INVENTION

An aspect of the present invention is to eliminate the above-mentioned problems with the conventional technology.

A feature of the present invention is to reduce the possibility that print material printed in a state where a user is away is left by only printing a file when user authentication is performed on a print apparatus after the file to be printed was transmitted by electronic mail from a mobile terminal to the print apparatus.

According to an aspect of the present invention, there is provided a print system having a print server and a printer apparatus, wherein the print server comprises: a receiving unit configured to receive an electronic mail transmitted from a mobile terminal; a generation unit configured to generate print data corresponding to an attachment file of the electronic mail received by the receiving unit; and a transmission unit configured to transmit to the print apparatus, as a print job, the print data generated by the generation unit and authentication information in a case where the authentication information is included in the electronic mail received by the receiving unit; and wherein the print apparatus comprises: an authentication unit configured to perform authentication based on the authentication information transmitted by the transmission unit and information input by a user; and a print unit configured to perform a printing of the print data in a case where the authentication performed by the authentication unit succeeded.

Further features and aspects of the present invention will become apparent from the following description of exemplary embodiment, with reference to the attached drawings.

### BRIEF DESCRIPTION OF THE DRAWINGS

FIG. 1 is a view for describing a print system according to an embodiment of the present invention.

FIG. 2 is a block diagram for showing a configuration of an access point according to the embodiment of the present invention.

FIG. 3 is a block diagram for showing a configuration of a mail server and a print server according to the embodiment of the present invention.

FIG. 4 is a block diagram for showing a configuration of a print apparatus according to the embodiment of the present invention.

FIG. 5 is a view for describing transmission of an electronic mail to the print server from a mobile terminal in the embodiment of the present invention.

FIG. 6 is a view for describing the print processing flow in the print system with flowcharts showing the processing of the mobile terminal, an AP, the servers and the print apparatus according to the embodiment of the present invention.

FIG. 7 is a view for showing a list of file types supported by the print server and applications according to the embodiment of the present invention.

FIG. 8 is a view for showing a table that stores an association of printer names and printer drivers for those printers.

FIG. 9 is a flowchart for describing print server processing for confirming a secure print function capability of the print apparatus according to the embodiment of the present invention.

FIG. 10 is a flowchart for describing user operation when electronic mail transmission is performed from the mobile terminal according to the embodiment of the present invention.

FIGS. 11A and 11B depict views illustrating examples of electronic mail screens of the mobile terminal.

FIG. 12 is a flowchart for describing print server processing for transmitting secure print job print data to the print apparatus according to the embodiment of the present invention.

FIG. 13 is a flowchart for describing print apparatus processing for receiving from the print server and printing print data according to the embodiment of the present invention.

FIG. 14 is a flowchart for describing secure print by the print apparatus according to the embodiments of the present invention.

FIGS. 15A through 15J depict views illustrating examples of secure print operation screens of the print apparatus according to the embodiment of the present invention.

### DESCRIPTION OF THE EMBODIMENTS

Embodiment of the present invention will be described hereinafter in detail, with reference to the accompanying drawings. It is to be understood that the following embodiments are not intended to limit the claims of the present invention, and that not all of the combinations of the aspects that are described according to the following embodiment are necessarily required with respect to the means to solve the problems according to the present invention.

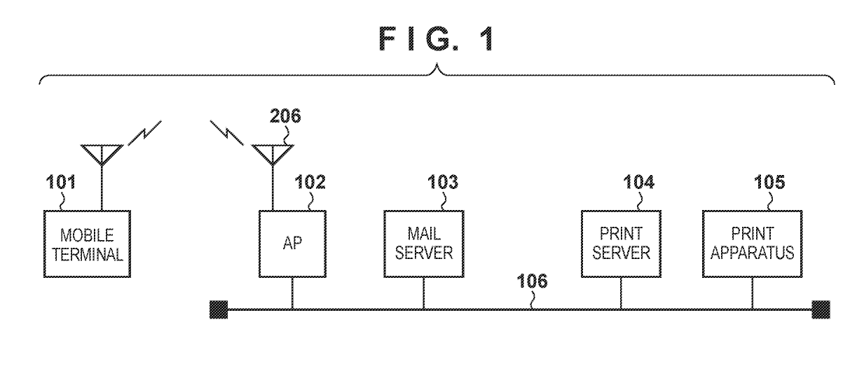

FIG. 1 is a view for describing a print system according to the embodiment of the present invention.

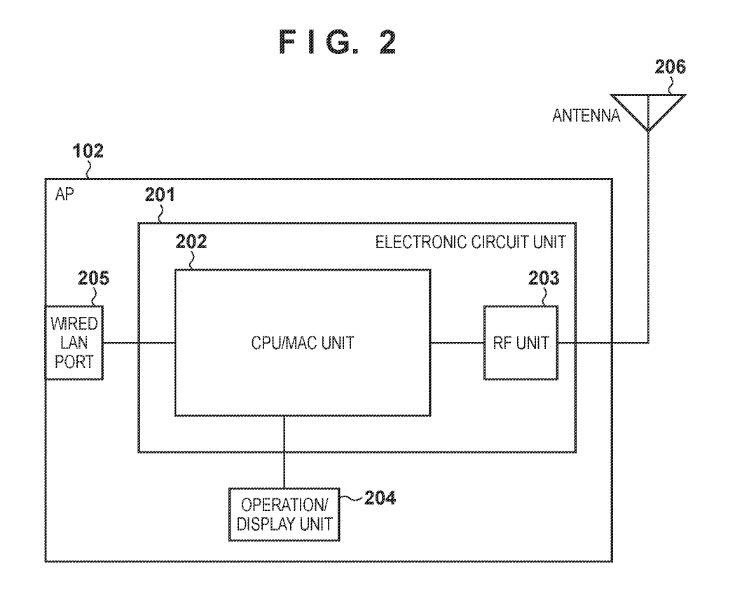

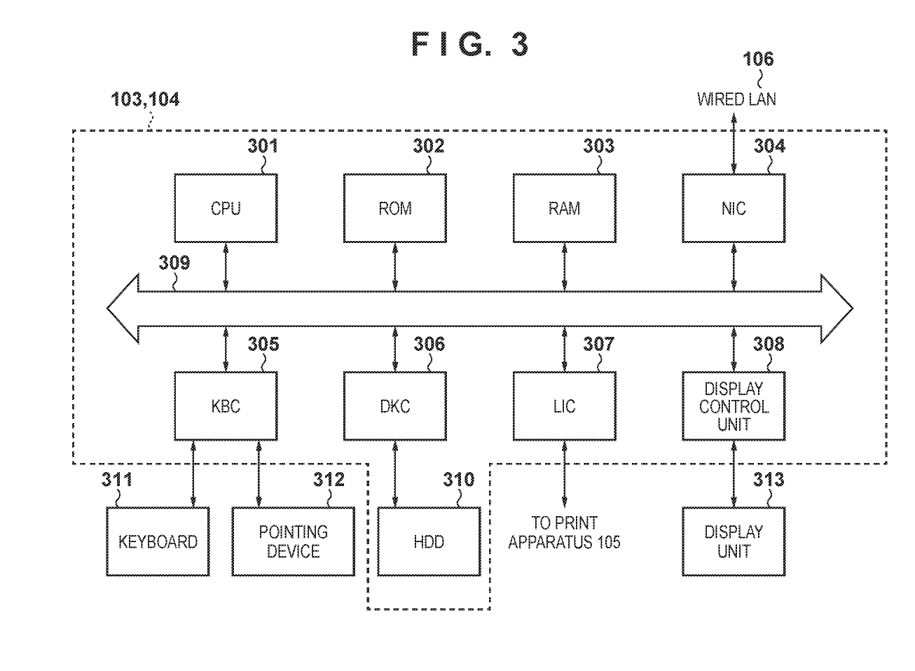

A mobile terminal 101 is an information terminal device of a size such that it can be carried by hand, on which an operating system (hereinafter referred to as “OS”) is installed, and upon the OS of which various software applications can be caused to operate. In the present embodiment, an electronic mail is transmitted by wireless communication by electronic mail software which is one of the software applications on the mobile terminal 101. An access point (hereinafter referred to as “AP”) 102 is an apparatus by which the mobile terminal 101 can connect to a wired LAN 106 via wireless communication. The internal configuration of the AP 102 is explained in detail in FIG. 2. A mail server 103 is a device taking the configuration of an information processing apparatus such as a general personal computer (hereinafter referred to as “PC”). As for a mail server function, the function is achieved by installing onto the mail server 103 and causing to operate server software. The configuration of the mail server 103 is explained in detail with reference to FIG. 3. An electronic mail transmitted from the mobile terminal 101 is sent to the mail server 103 via the access point 102 and retained.

A print server 104 is a device taking the configuration of an information processing apparatus such as a general PC similarly to the mail server 103. The configuration of the print server 104 is also explained with reference to FIG. 3. On the print server 104, printer drivers for various print apparatuses connected via the wired LAN 106 are installed. A print apparatus 105 prints an image onto a sheet of paper in accordance with print data in response to a print command from the print server 104. The wired LAN (Local Area Network) 106 comprises a network to which the AP 102, the mail server 103, the print server 104 and the print apparatus 105 connect by, for example, Ethernet (registered trademark) cable. Note, in the present embodiment, the print server and the mail server are configured as separate information processing apparatuses, but they may be configured as a single information processing apparatus. In other words, they may be configured as an information processing apparatus having a later described mail server function, mail client function, and printer control function.

FIG. 2 is a block diagram for showing a configuration of the access point 102 according to the embodiment of the present invention. The access point 102 can communicate wirelessly with apparatuses connected to the wireless communication network (for example, the mobile terminal 101) and two-way communication is possible via the wired LAN 106.

The AP 102 comprises an electronic circuit unit 201, an operation/display unit 204 and a wired LAN port 205. The wired LAN port 205 has a connector to which an Ethernet (registered trademark) cable for connecting to the wired LAN 106 can be connected. The operation/display unit 204 has, for example, a display unit and various key switches, and the like, and performs status display for the AP 102 main body, and status display for each of the ports and so on. Also, it comprises a switch or the like for performing connection to the wireless LAN. Furthermore, the AP 102 has a security function for safely performing wireless LAN connection.

The AP 102 comprises a CPU/MAC unit 202 and a wireless frequency transmission/receiving unit (hereinafter referred to as “RF unit”) 203. The CPU/MAC unit 202 comprises an internal CPU (not shown) and a MAC (Media Access Control) (not shown). The CPU includes devices such as a processor and a memory, and these devices communicate with each other via a bus (not shown). Also, the MAC has a part that performs wireless communication and a part that performs wired communication. As shown in FIG. 2, the CPU/MAC unit 202 and the RF unit 203 are both implemented in the electronic circuit unit 201. In the RF unit 203 an antenna 206 for sending and receiving radio waves is arranged. The CPU/MAC unit 202 is connected to the operation/display unit 204, the RF unit 203 and the wired LAN port 205. Also, the AP 102 is connected to the wired LAN 106 via an Ethernet (registered trademark) cable (not shown). The Ethernet (registered trademark) cable is connected at one end to the wired LAN port 205, and the other end is connected to a network hub (not shown.

FIG. 3 is a block diagram for showing a configuration of the mail server 103 and the print server 104 according to embodiment of the present invention.

On the servers, a CPU 301, a ROM 302, a RAM 303, and a network interface controller (NIC) 304 are connected via a bus 309. Also, a keyboard controller (KBC) 305, a display controller (DKC) 306, a local interface controller (LIC) 307 and a display control unit 308 are connected via the bus 309. To the NIC 304 an Ethernet (registered trademark) cable connected to the wired LAN 106 is connected.

To the KBC 305 a keyboard 311 and a pointing device 312 are connected. To the DKC 306 a hard disk drive (HDD) 310 is connected. To the LIC 307 a peripheral device is connected via a local interface such as USB. To the display control unit 308 a display unit 313 is connected. In the ROM 302, a basic I/O program, an operating system (OS), and the like are stored. The CPU 301 manages and executes application programs based on the execution of the OS.

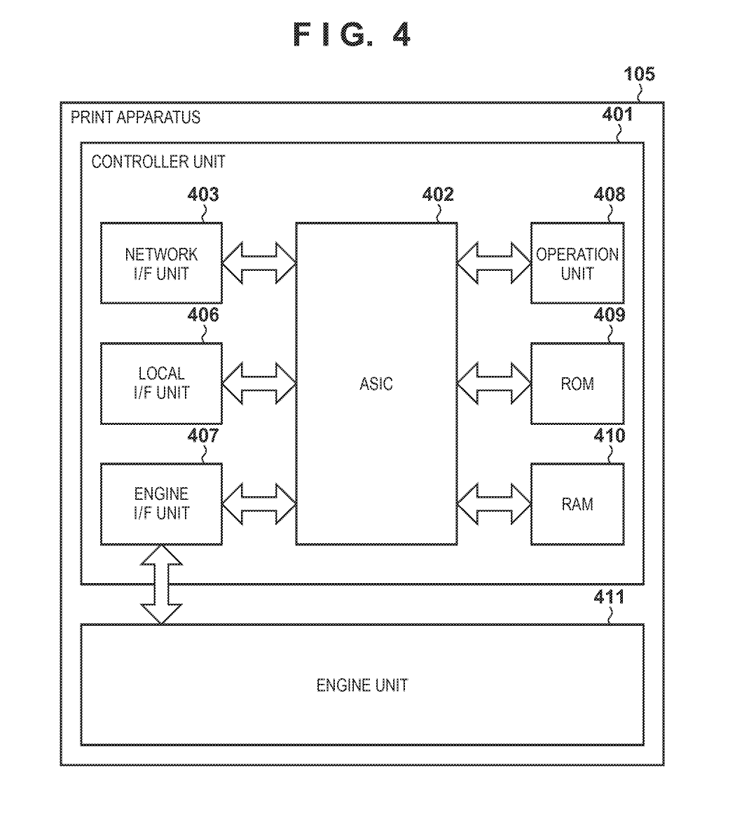

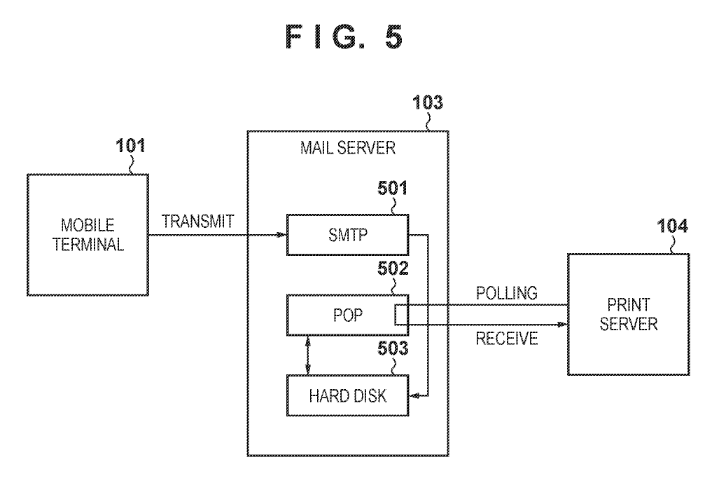

In the case of the print server 104, a print application of the mobile terminal 101 according to the present embodiment, various application programs, and printer drivers are stored in the HDD 310. Also, the print server 104 has a mail client function and a printer control function, and using these it realizes a function for printing a file attached to an electronic mail. Note, the mail server function of the mail server 103 is described later referring to FIG. 5.

FIG. 4 is a block diagram for showing a configuration of a print apparatus 105 according to the embodiment of the present invention.

A controller unit 401 includes such things as a network interface unit 403, a local interface unit 406 and an engine interface unit 407, and it processes received print data. An ASIC 402 has embedded in it a CPU (not shown), and mostly performs processing for passing print data to an engine unit 411. The controller unit 401 also comprises an operation unit 408 which can convey the status of the printer 105 to a user and can facilitate operation input from the user, a ROM 409 which stores such things as programs, and a RAM 410 which provides, in a case where print data is processed, an extraction area for an image and a work area for programs and so on. The network interface unit 403 and the local interface unit 406 perform the sending a receiving of data with the PC via an external interface. The external interface is assumed to be Ethernet (registered trademark), USB, or the like. Also, an engine interface unit 407 performs a print by outputting print data from the controller unit 401 to the engine unit 411.

FIG. 5 is a view for describing transmission of an electronic mail to the print server 104 from the mobile terminal 101 in the embodiment of the present invention.

Firstly, explanation will be given for the function of the mail server 103. Inside of it an SMTP (Simple Mail Transfer Protocol) server 501 and a POP (Post Office Protocol) server 502 are running, and each of them performs very different operations. The mobile terminal 101 transmits an electronic mail with its own electronic mail software. The transmitted electronic mail is received by the mail server 103 connected to the wired LAN 106 via the AP 102. Here, the electronic mail software of the mobile terminal 101 specifies the predetermined mail address (destination) of the mail server 103. This mail address is, for example, “print@mailprint.xxx.co.jp”.

The mail server 103, having received this electronic mail, stores the electronic mail in a hard disk 503, and finishes the operation.

Next, operation in which the print server 104 receives the electronic mail from the mail server 103 will be explained.

The print server 104 performs polling/receiving, on the POP server 502 of the mail server 103, to check for the existence of the receipt of an electronic mail, as a print application that pairs with the mobile terminal 101 commands. At that point, the print server 104 specifies the aforementioned predetermined mail address (destination). Also, the polling interval may be set appropriately by the print application that pairs with the mobile terminal 101 according to the present embodiment.

The POP server 502 makes a request for a user name and a password in response to an access from the print server 104. If a correct user name and password are verified, accumulated received mails are checked and the existence of an electronic mail addressed to the print server 104 is replied. The POP server 502 passes a received electronic mail to the print server 104 and finishes the operation in a case where the electronic mail exists in the POP server 502.

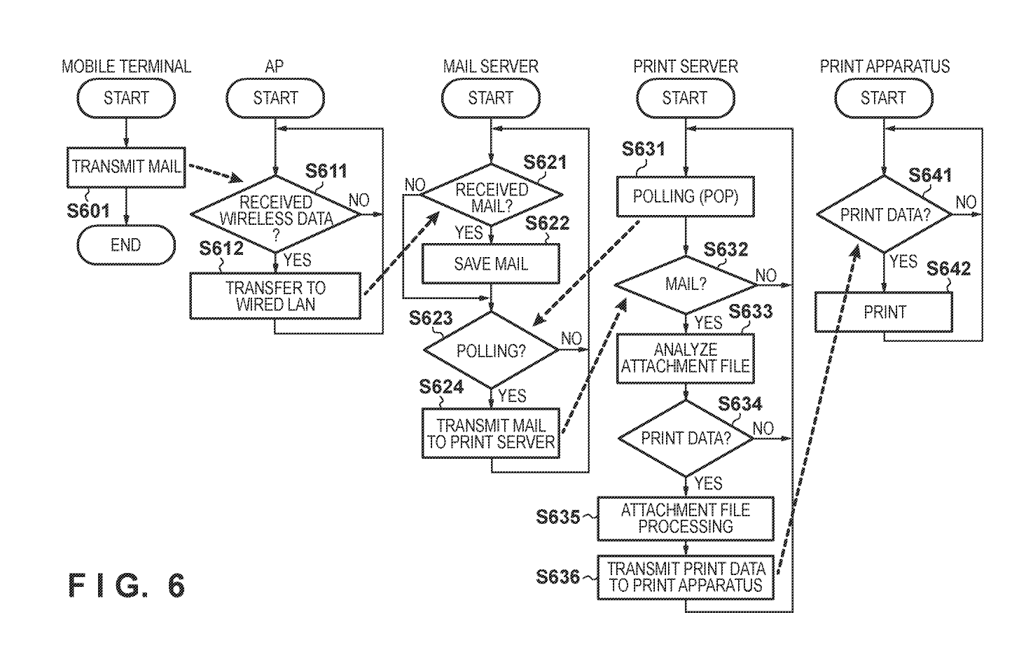

FIG. 6 is a view for describing the print processing flow in the print system with flowcharts showing the processing of the mobile terminal, an AP, the servers and the print apparatus according to embodiment of the present invention. In FIG. 6, the entire flow, from when the mobile terminal 101 transmits the electronic mail to when the print apparatus 105 prints the attachment file, is shown.

Firstly in step S601, electronic mail software on the mobile terminal 101 that a user holds transmits an electronic mail, to which is attached a file to be printed, to the mail address of the mail server 103.

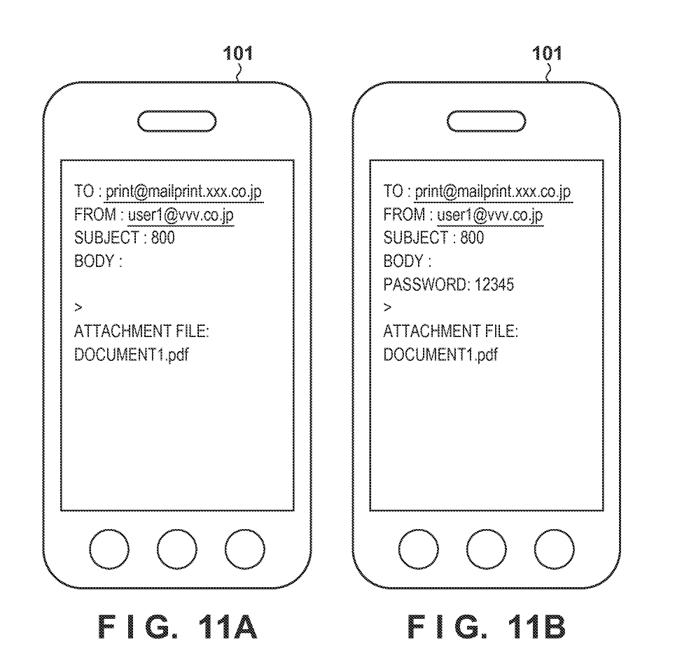

FIG. 11A shows an example of a transmission screen of the electronic mail software on the mobile terminal 101 according to the embodiment. Here, for example, the address “print@mailprint.xxx.co.jp” of the mail server 103 is inserted into the “To:” field and, for example, “800” is entered into the “Subject:” field as the printer name. Here, the printer name of the print apparatus 105 on which printing is desired is entered. In this case the transmission is by wireless LAN. The electronic mail software on the mobile terminal 101 finishes operation here.

With this the access point 102, in step S611, receives the electronic mail from the mobile terminal 101 via the wireless LAN as wireless data. Specifically, a wireless signal is input from the antenna 206, and the wireless signal is converted from analog signal to digital signal by the RF unit 203. At a later stage, the CPU/MAC unit 202 analyzes the destination and route of the digital signal and the transmission to the wired LAN 106 is performed via the wired LAN port 205. In this way, the AP 102, in step S612, transmits the electronic mail via the wired LAN 106 to the mail server 103 (the SMTP server 501 in FIG. 5).

When, in step S621, the mail server 103 receives the electronic mail, the processing proceeds to step S622, and the mail server 103 stores the electronic mail and the file attached to it in the hard disk 310.

Meanwhile, the print server 104, in step S631, is polling the POP server 502 of the mail server 103 at a regular interval. The details of this operation have already been explained using FIG. 5. Next, the processing proceeds to step S623, and when the print server 104 confirms (polling) that there is a new mail on the mail server 103, the processing proceeds to step S624 and the mail server 103 transmits an electronic mail corresponding to the print server 104 and an attachment file (POP server 502).

In step S632, when the print server 104 receives the electronic mail, the processing proceeds to step S633, and the print server 104 analyzes the attachment file attached to the electronic mail. Note, up until the print server 104, in step S633, analyzes the file, the handled data is called an “attachment file”, but after the print server 104, in step S633, analyzes the attachment file, the extracted data to be printed that is called “print data”. Next, the processing proceeds to step S634, and based on the analysis result in step S633, it is determined whether or not the attachment file of the received electronic mail is data to be printed, and if so the processing proceeds to step S635. In step S635, the print server 104, looking at the file extension of the attachment file, launches an application stored in the HDD 310 in the print server 104, and using a print function of the application, generates print data.

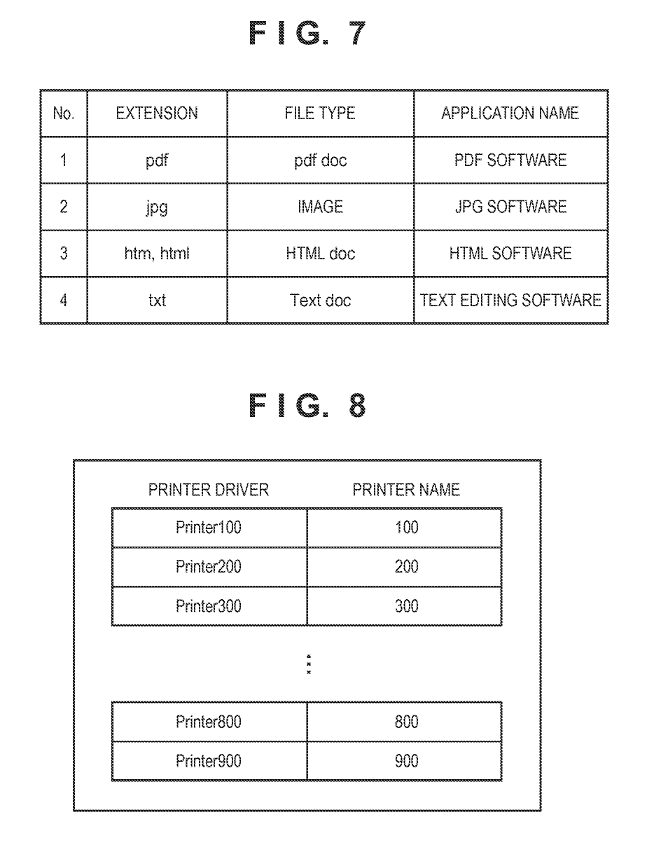

FIG. 7 is a view for showing a list of file types supported by the print server 104 and applications according to the embodiment of the present invention.

Here, file extensions and their file types, as well as the names of the applications that handle these files are associated and registered. With this, by determining beforehand which application of the print server 104 corresponds to the file extension of a file attached to the electronic mail, it is possible to launch the print function of the right application for the extension and to generate print data.

Next, the processing proceeds to step S636, and by launching a printer driver associated with the target printer name that the print server 104 acquired from the subject of the received mail, the print data is developed into the RAM 303, and transmitted as print data to the specified print apparatus 105. Note, the printer driver and the “printer name” of the subject of the electronic mail are stored in a table like the one in FIG. 8 for example.

FIG. 8 is a view for showing a table that stores an association of printer names and printer drivers for those printers.

Referring to this table, it can be seen that the printer driver of the print apparatus 105 with aforementioned printer name “800” is “Printer800”.

Also, the print server 104 adds the printer driver and printer name information to this table when a new print apparatus 105 connects to the wired LAN 106 or connects to the local interface of the print server 104. Note, the printer name is one example of an identifier for identifying a printer, but so long as it is information that can identify a printer, other information, such as an IP address, may be used. In that case, in the table of FIG. 8, information of the IP address, etc would be associated with the printer driver and managed.

When the print apparatus 105, in step S641, receives print data from the print server 104, the processing proceeds to step S642 and the print apparatus 105 prints an image onto a sheet of paper based on the print data.

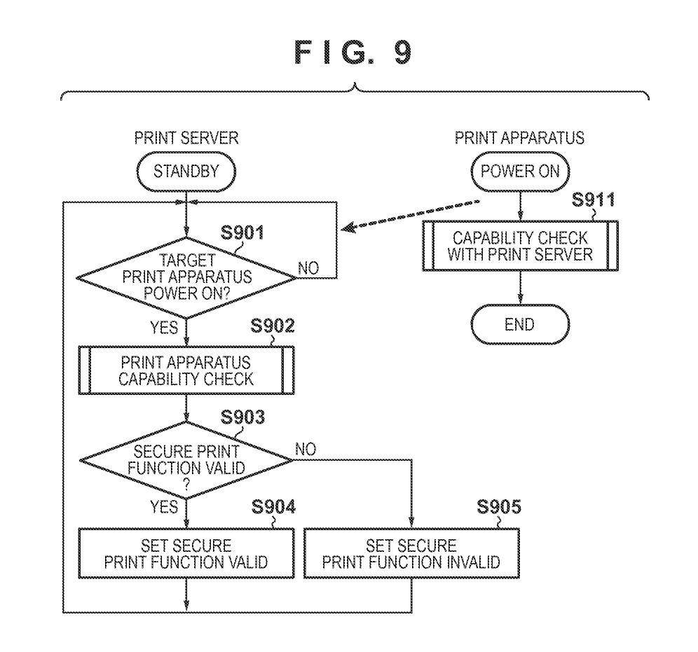

FIG. 9 is a flowchart for describing print server processing for confirming a secure print function capability of the print apparatus 105 according to the embodiment of the present invention. This processing is realized by the CPU 301 of the print server 104 executing a program stored in the ROM 302.

A “secure print” is a function in which, firstly, at the time of print job input, the print job is not input until after a user enters a password, and after that, when printing, the user selects the print job with the operation unit 408 of the print apparatus 105, and enters a password, and only in a case where the password entered when inputting the print job and the password entered on the print apparatus when printing match does printing start.

Firstly, in step S901, the CPU 301 determines whether or not the power of the print apparatus 105 connected to the wired LAN 106 or to the local interface is on. If it determines that the power of the print apparatus 105 is on, the processing proceeds to step S902 and the CPU 310 checks the capability of the print apparatus 105. Next the processing proceeds to step S903 and the CPU 301 determines whether or not a secure print function of the print apparatus 105 is valid. If it determines that it is valid, the processing proceeds to step S904, and the CPU 301 sets that the secure print function is valid, and the processing proceeds to step S901. On the other hand, if it is determined that the secure print function of the print apparatus 105 is not valid, the processing proceeds to step S905, and it is set that the secure print function is invalid and the processing proceeds to step S901. Note, the settings in step S904 and in step S905 are stored in the RAM 303 of the print server 104.

On the other hand, the processing of the print apparatus 105 initiates as a result of the power of the print apparatus 105 being turned on, and in step S911, a capability check is performed with the print server 104, and whether or not the secure print function is valid is reported to the print server 104, and the flow ends.

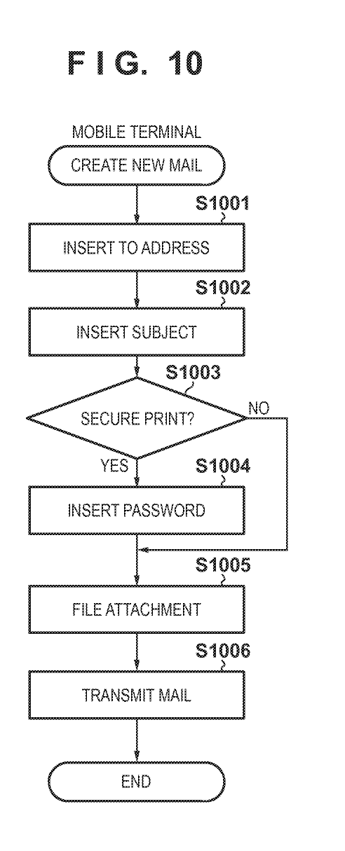

FIG. 10 is a flowchart for describing user operation when electronic mail transmission is performed from the mobile terminal 101 according to the embodiment of the present invention.

Firstly in step S1001, the user enters the electronic mail address of the mail server 103 into the destination in order to perform a print from the mobile terminal 101, and in step S1002 the user enters the printer name of the print apparatus 105 on which he wishes to print.

Here, as shown in FIG. 11A, the address “print@mailprint.xxx.co.jp” of the mail server 103 is inserted into the destination (To) field and printer name “800” is, for example, entered into the subject field.

Next, the processing proceeds to step S1003, and it is determined whether or not to perform a secure print, and in a case where a secure print is performed, the processing proceeds to step S1004, and the password is entered into the body of the electronic mail. Here, as shown in FIG. 11B, in the body of the mail, for example, “12345” is entered as the password, secure print is instructed and the processing proceeds to step S1005. On the other hand, in a case where secure print is not performed, the processing proceeds to step S1005. In step S1005, a file to be printed is attached to the electronic mail, and next in step S1006, the electronic mail is transmitted.

In this way, the user, can perform user authentication at the printer and specify the secure print to be printed when a file to be printed is transmitted by an electronic mail from the mobile terminal 101.

FIG. 12 is a flowchart for describing print server processing for transmitting print data of a secure print job to the print apparatus 105 according to the embodiment of the present invention. This processing is realized by the CPU 301 of the print server 104 executing a program stored in the ROM 302.

Firstly, in step S1201, the CPU 301, in the same way as in the previously described step S631 in FIG. 6, polls the POP server 502 of the mail server 103 at regular intervals. Next, in step S1202, when the CPU 301 confirms the mail of the mail server 103, the processing proceeds to step S1203, and the CPU 301 receives the mail and analyzes the attachment file of the electronic mail. Next, in step S1204, as a result of the analysis, it is determined whether or not the attachment file of the received electronic mail is data to be printed, and in the case where it is, the processing proceeds to step S1205, whereas in the case where it isn't the processing proceeds to step S1201.

In step S1205 the CPU 301, based on the information stored in step S904 or step S905 of FIG. 9, determines whether or not the secure print function of the print apparatus 105 that is the target of the print is valid. If the secure print function is determined to be valid, the processing proceeds to step S1206, and if it is determined to be invalid, the processing proceeds to step S1212. In step S1206, the CPU 301 analyzes the body of the received electronic mail. Next in step S1207, the CPU 301 determines whether or not the password is specified in the body of the mail. Here, if it is determined that the password is specified, the processing proceeds to step S1208, the password is set as the “secure print password” of the print job information, and the processing proceeds to step S1210. On the other hand, in step S1207, when the password is not specified, the processing proceeds to step S1209, and the user name part of the POP received From address (the transmission origin address) is set as the “secure print password” of the print job information. For example, the password is set to the “user1” part of “user1@canon.co.jp”, which is the From address, “@” is added and the processing moves on to step S1210.

In step S1210, the CPU 301 sets the user name of the print job information to “print from mobile terminal”. Next the processing proceeds to step S1211, and the CPU 301 sets the output method of the print job information to be “secure print”, and the processing proceeds to step S1212.

In step S1212, similarly to previously described step S635 in FIG. 6, the CPU 301 launches an application stored in the HDD 310 of the print server 104 corresponding to the file extension of the attachment file. Then, using the print function of the application, print data is generated and the processing proceeds to step S1213. In step S1213, the CPU 301, by launching the printer driver associated with the output destination printer name acquired from the subject of the received mail, print data is extracted into the RAM 303 and transmitted as print data to the specified print apparatus 105.

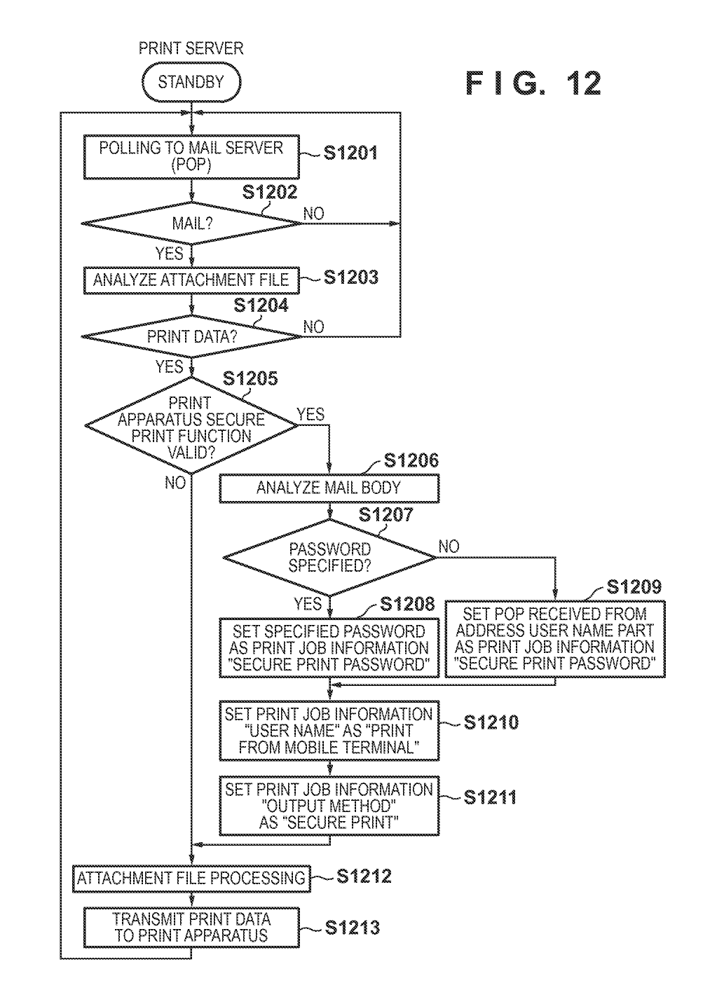

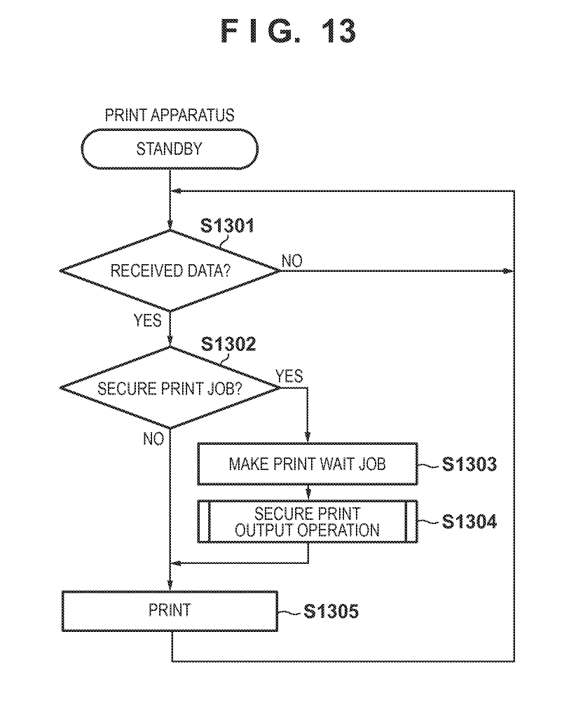

FIG. 13 is a flowchart for describing print apparatus processing for receiving from the print server 104 and printing print data according to the embodiment of the present invention.

Firstly, in step S1301, when print data is received from the print server 104, the CPU of the print apparatus 105 proceeds to step S1302 and determines whether or not it is a secure print job. In the case of a secure print job, the processing moves to step S1303 and in the case where it is not a secure print job, the processing proceeds to S1305, and based on the print data, the print is executed. In step S1303, the CPU retains print data in the print apparatus 105 as a print wait job. Next the processing proceeds to step S1304, and when later explained secure print output operation is performed, the processing proceeds to step S1305, the image is printed onto the sheet according to the print data, and the processing ends.

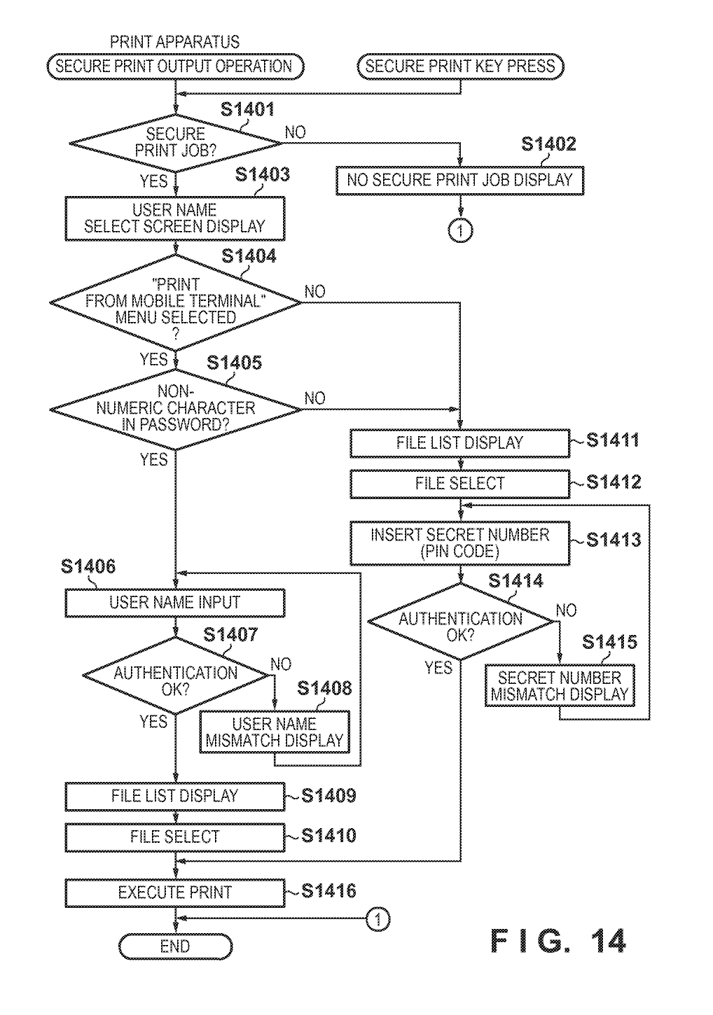

FIG. 14 is a flowchart for describing secure print by the print apparatus 105 according to the embodiment of the present invention.

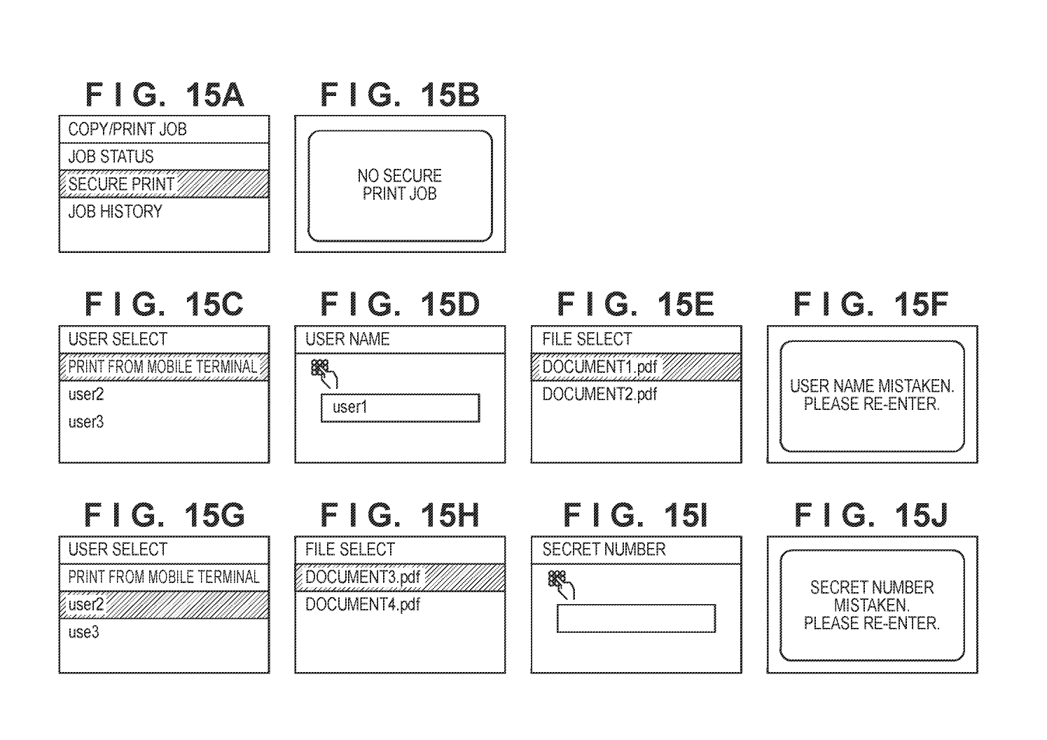

FIGS. 15A through 15J depict views illustrating examples of secure print operation screens of the print apparatus 105 according to the embodiment of the present invention.

The processing of FIG. 14 is started by secure print being selected on the copy/print job screen shown as an example in FIG. 15A or by a secure print key being pressed.

Firstly, in step S1401, the CPU of the print apparatus 105 (hereinafter referred to as “CPU”) determines whether or not there is a secure print job. If it is determined that there is a secure print job, the processing proceeds to step S1403, and if it is determined that there is no secure print job, the processing moves to step S1402, “no secure print job” display is performed and processing ends. FIG. 15B shows and example of “no secure print job” display wherein display of something to the effect of “NO SECURE PRINT JOB” is performed and the processing ends.

In step S1403 the CPU displays a selection screen, shown as examples in FIG. 15C and FIG. 15G, for the user that input the secure print job. Here when there is a secure print job from the mobile terminal 101, “print from mobile terminal” set as the “user name” of the print job information in the previously described step S1210 of FIG. 12 is displayed as a user name selection option. Next the processing moves to step S1404. In step S1404, the CPU determines whether or not “print from mobile terminal” was selected in the previously described user selection screen. In a case where “print from mobile terminal” was selected, the processing proceeds to step S1405, and in a case where a user name other than “print from mobile terminal” was selected, the processing proceeds to step S1411.

In step S1405, the CPU determines whether or not non-numeric characters are included in the secure print password of the print job information selected in previously described step S1208 or step S1209 of FIG. 12. Here, when it is determined that non-numeric characters are included in the password, the processing proceeds to step S1406, and when the password comprises only numeric characters, the processing moves to step S1411.

In step S1406, the CPU displays the user name input screen shown in FIG. 15D as an example. Next in step S1406, when the user name is entered, the processing moves to step S1407. In step S1407, the CPU compares the user name with the user name part of the POP received From address set as the secure print password of the print job information in the previously describe step S1209 of FIG. 12. Next, when the user names match, as authentication has succeeded, the processing moves to step S1409. When they do not match, as the authentication has failed, the processing moves to step S1408, something to the effect that the user names do not match is displayed, and the processing returns to step S1406. FIG. 15F shows an example of display in a case where the user names do not match (step S1408), and display of something to the effect of “USER NAME MISTAKEN. PLEASE RE-ENTER” is performed.

In step S1409, the CPU displays a list of files for secure print jobs for which the user name entered in step S1406 or step S1407 matches, as FIG. 15E shows as an example, and the processing moves to step S1410. Next, in step S1410, when the file to be printed is selected from the plurality of files, the CPU moves the processing to step S1416 and the print is executed. When this printing finishes, the processing ends.

Here, in a case where the processing proceeds from step S1405 to step S1406, as described above, because it is the case that, for example, a part of the From address of the electronic mail was set as the password, in step S1406 and step S1407 authentication is performed by the user name. When the user names match, it is determined that it is the user that transmitted the electronic mail, and it is determined that the user authentication succeeded.

On the other hand, as FIG. 15H shows as an example, the CPU displays a list of files for secure print jobs for which the user names match, and the processing moves to step S1412. Next, when in step S1412 a file is selected from the plurality of files, the CPU moves the processing to step S1413. In step S1413, a secret number insertion screen, shown in FIG. 15I as an example, is displayed. Next, when insertion of the secret number is performed, the processing moves to step S1414. In step S1414, the CPU compares the secret number with the secure print password (here it is the password in the body of the mail) of the print job information set in the previously described step S1208 of FIG. 12. Next, when the secret number matches, as the authentication is a success, the processing moves to step S1416, printing is executed, and after the print, the processing ends. On the other hand, when in step S1414 the secret number does not match, as the authentication failed, the processing proceeds to step S1415, something to the effect that the secret number does not match is displayed and the processing returns to step S1413. FIG. 15J shows an example of when it is displayed that the secret number does not match, and display of something to the effect of “SECRET NUMBER MISTAKEN. PLEASE RE-ENTER” is performed.

As explained above, according to the present embodiment the user transmits an electronic mail having an attachment file and having a password in the electronic mail body from a mobile terminal. Next, on the print apparatus by which the attachment file is desired to be caused to print, the file attached to the electronic mail is selected, and by entering a password, printing of the attachment file becomes possible. Also, even in a case where a password was not entered when the electronic mail with the attachment file is transmitted, instead of the password by authenticating by entering the user name part of the From address, for example, the attachment file can be printed.

With this, a secure print of a file of an electronic mail transmitted from a mobile terminal becomes possible, and because the print material is printed in a state in which the user is beside the print apparatus, there is an effect of reducing the danger of the print material being mixed up with other print materials and seen by a third party.

### Other Embodiment

The present invention is not limited to the above described embodiment and various changes are possible. For example, for the communication method by which the mobile terminal 101 transmits the electronic mail was explained in the present embodiment using wireless LAN as an example, but the present invention is not limited to this and, for example, a mobile telephone network may also be used.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-146082, filed Jun. 28, 2012, which is hereby incorporated by reference herein in its entirety.

What is claimed is:

1. A print system having a print server and a printer apparatus,
wherein the print server comprises:
a receiving unit configured to receive an electronic mail transmitted from a mobile terminal;
a generation unit configured to generate print data corresponding to an attachment file of the electronic mail received by the receiving unit; and
a transmission unit configured to transmit to the print apparatus, as a print job, the print data generated by the generation unit and authentication information in a case where the authentication information is included in the electronic mail received by the receiving unit; and
wherein the print apparatus comprises:
an authentication unit configured to perform authentication based on the authentication information transmitted by the transmission unit and information input by a user; and
a print unit configured to perform a printing of the print data in a case where the authentication performed by the authentication unit succeeded.

2. The print system according to claim 1, wherein the transmission unit transmits, in a case where the authentication information is not included in the electronic mail received by the receiving unit, information included in a transmission origin address of the electronic mail, as the authentication information, together with the print data, and the authentication unit performs the authentication based on the information included in the transmission origin address transmitted by the transmission unit and information input by a user.

3. The print system according to claim 2, wherein the information included in the transmission origin address of the electronic mail is a user name part of the transmission origin address.

4. The print system according to claim 1, wherein the print server further comprises:
a determination unit configured to determine whether or not a secure print function of the print apparatus is valid; and
a checking unit configured to check whether or not the authentication information is included in the electronic mail received by the receiving unit by analyzing the electronic mail received by the receiving unit, in a case where the determination unit determined that the secure print function of the print apparatus is valid.

5. The print system according to claim 1, wherein the print server further comprises a management unit configured to associate and manage a plurality of print apparatuses and drivers for the respective printers, and
wherein the generation unit generates the print data using a driver associated with a printer specified in the electronic mail received by the receiving unit.

6. The print system according to claim 1, wherein the print apparatus further comprises:
a storage unit configured to store a plurality of print jobs; and
a selection unit configured to select a target print job from a plurality of print jobs stored in the storage unit according to a selection of a user, and
wherein the authentication unit performs the authentication corresponding to the target print job selected by the selection unit.

7. A print server comprising:
a receiving unit configured to receive an electronic mail transmitted from a mobile terminal;
a generation unit configured to generate print data corresponding to an attachment file of the electronic mail received by the receiving unit; and
a transmission unit configured to transmit to a print apparatus, as a print job, the print data generated by the generation unit and authentication information, in a case where the authentication information is included in the electronic mail received by the receiving unit,
wherein printing of the print data is performed on the print apparatus in a case where the authentication based on the authentication information transmitted by the transmission unit and authentication information input by a user into the print apparatus succeeded.

8. A control method of a print server comprising:
receiving an electronic mail transmitted from a mobile terminal;
generating print data corresponding to an attachment file of the received electronic mail; and
transmitting to a print apparatus, as a print job, the generated print data and authentication information in a case where the authentication information is included in the received electronic mail,
wherein printing of the print data is performed on the print apparatus in a case where the authentication based on the transmitted authentication information and authentication information input by a user into the print apparatus succeeded.

9. A non-transitory computer readable storage medium storing a program that causes a computer to execute the control method according to claim 8.
